(19) United States
(12) Patent Application Publication
(10) Pub. No.: US 2012/0182489 A1
(43) Pub. Date: Jul. 19, 2012

(54) Pixel Structure with Pre-charge Function

(76) Inventors: Kuang-Kuei WANG, Taoyuan City (TW); Chin-Hai Huang, Pingzhen City (TW)

(21) Appl. No.: 13/108,980

(22) Filed: May 16, 2011

(30) Foreign Application Priority Data
Jan. 18, 2011 (TW) 100201129

(51) Int. Cl. G02F 1/1368

(52) U.S. Cl. 349/38

(57) ABSTRACT

The present invention discloses a pixel with pre-charge function. Being added into every pixel of a TFT-LCD, a pre-charging transistor can charge the capacitor of a pixel to a pre-designed voltage in advance before the pixel updates its gray level. Owing to the reduced charging voltage, the charging and discharging time is reduced thereof when the pixel updates its grey level. Furthermore, the problems of low contrast ratio and flicker, due to insufficient charging or discharging time, are solved.

### CROSS-REFERENCE TO RELATED APPLICATION

This present application claims priority to TAIWAN Patent Application Serial Number 100201129, filed Jan. 18, 2011, which is herein incorporated by reference.

### TECHNICAL FIELD

The present invention relates to a pixel structure of a display, and particularly to a pixel structure with pre-charge function. Applied on Thin Film Transistor Liquid Crystal Display (TFT-LCD), the pixel of the present invention reduces the charging and discharging time so as to rapidly update the gray level of a pixel and to solve the problems of low contrast and flicker which are due to the insufficient charging.

### BACKGROUND OF THE RELATED ART

Nowadays, Thin Film Transistor Liquid Crystal Display (TFT-LCD) is the most popular display. As shown in FIG. 1, the display area 10 of a TFT-LCD shows a crisscross pattern which is formed by a plurality of scan lines 11 and a plurality data lines 12, wherein the intersection area of a scan line 11 and a data line forms a pixel P. Each pixel contains a transistor (e.g. TFT) to be the switch of a unit pixel, a scan line, a data line and a storage capacitance Cs. The first electrode of capacitance Cs is connected to one node of the transistor and the second node of capacitance Cs is connected to a common voltage Vcom. When in operation, scan lines 11 will be sequentially activated to turn on the TFT and then a data line 12, via the turned-on TFT, charges the storage capacitance Cs to a gray scale voltage. When the TFT is turned off, the storage capacitance Cs still keeps the gray scale voltage until the TFT is turned on again to update a new gray scale voltage. The scan lines 11 are sequentially activated to turn on every TFT on a row and new gray scale voltages of storage capacitance Cs are updated by source lines 12, and consequently a new frame is update thereof.

Owing to the cost down requirement, currently many TFT-LCDs use the technique of data line reducing, as shown as in FIG. 2, such as U.S. Pat. No. 5,151,689 applied by Hitachi and published in 1992, and US patent US2000-23135 applied by CASIO and published in 2000. The data line reducing technique can reduce the data lines to ½ or ⅓ so as to save the numbers of source driver IC and to save the cost.

However, while using aforementioned data reducing technique, the scan lines will increase two or three times, and therefore the scan speed should increase two or three times to maintain the same frame rate. Consequently, the duration of activation for every scan line reduces to ½ or ⅓. Nowadays, the resolution of TFT-LCD is increased more and more so the data line reducing technique is subject to insufficient charging or discharging time for a pixel, which causes the problems of low contrast and flicker thereof.

Furthermore, owing to the moving speed of the conductive carrier of a TFT decreases with the decrease of temperature, the charging current for a pixel will decrease with the decrease of temperature as well. The lowest temperature specification for vehicle application TFT-LCD is about −40° C., in which the charging current of a TFT will tremendously reduce and the display will accordingly exhibit the problems of low contrast and flicker.

One approach to overcome the insufficient charging or discharging caused by the data line reducing technique and the low temperature environment is to increase the W/L of a TFT. However, once the W/L of TFT is increased, the parasitical capacitance will increase accordingly and the feed-through voltage, which causes the image sticking issues, of a pixel will increase as well. One approach to reduce the feed-through voltage is to increase the storage capacitance Cs, however the approach will reduce the opening ratio of a pixel and cause insufficient brightness thereby.

### SUMMARY

The present invention discloses a pixel structure with pre-charge function. One extra transistor, being a pre-charging switch, is added into every unit pixel. Before the storage capacitance of a unit pixel updates its gray scale voltage, the pre-charging switch will be turned on and the storage capacitance is charged to a common voltage in advance. Hence, the charging or discharging time can be reduced while a unit pixel updates its gray scale voltage.

The present invention discloses a pixel structure with pre-charge function. The pixel structure exhibits a pixel array which comprises a plurality of scan lines and a plurality of data lines, wherein a unit pixel formed between two adjacent scan lines and two adjacent data lines. Every one unit pixel includes: A storage capacitance having a first electrode (or an upper electrode) and a second electrode (or a lower electrode). A first transistor charges the storage capacitance of a unit pixel. The first transistor includes three nodes: a gate, a source and a drain, wherein the gate is the control node to control ON/OFF of the transistor and the drain is electrically connected to the first electrode of the storage capacitance of the unit pixel. A second transistor pre-charges a second storage capacitance of a lower row unit pixel. The second transistor includes three nodes: a gate, a source and a drain, wherein the gate is the control node to control ON/OFF of the transistor and the drain is electrically connected to the first electrode of the second storage capacitance of the lower row unit pixel. The unit pixel and lower row unit pixel share the same data line. A scan line electrically connects with the gates of the first transistor and the second transistor to drive the two transistors. A data line electrically connects with the source of the first transistor to charge the storage capacitance to a gray scale voltage. A common voltage line electrically connects to the source of the second transistor and the second electrode of the other unit pixels in the pixel array.

The first transistor of every unit pixel is a pixel switch to control ON/OFF of a unit pixel and the second transistor is a pre-charge switch to pre-charge a lower row unit pixel (i.e. a unit pixel sits on the next row and shares the same data line with a targeted unit pixel).

When the scan line activates the gates of the first transistor and the second transistor, the two transistors are turned on. The data line, via the first transistor, charges the first electrode of the storage capacitance of the unit pixel to a gray scale voltage and the common voltage line, via the second transistor, charges the first electrode of the second storage capacitance of the lower row unit pixel to a common voltage.

The storage capacitance of a unit pixel includes the parasitic capacitance between the first and the second electrodes and an extra designed capacitance. The first and the second transistors in the pixel array include Thin Film Transistor (TFT) and the other transistors which have three nodes. The transistors act as switch, wherein one node of the transistor is the control node to control the connection or disconnection between the other two nodes. The second electrodes of all the storage capacitances in the pixel array are connected together and coupled with the common voltage line.

The drain of the first transistor of the unit pixel is electrically connected to a drain of a second transistor of an upper row unit pixel (i.e. a unit pixel sits on the previous row and shares the same data line with a targeted unit pixel). The gate of the second transistor of the upper row unit pixel is controlled by an upper scan line, and the source of the second transistor of the upper row unit pixel is electrically connected to the common voltage line. When the upper scan line turns on the second transistor of the upper row unit pixel, the scan line is off and the first electrode of the storage capacitance of the unit pixel is charged to the common voltage by the second transistor of the upper row unit pixel.

The drain of the second transistor of the unit pixel is electrically connected to a drain of a first transistor of the lower row unit pixel. The gate of the first transistor of the lower row unit pixel is controlled by a lower scan line, and the source of the first transistor of the lower row unit pixel is electrically connected to the data line. When the scan line turns on the first transistor and the second transistor of the unit pixel, the lower scan line is off. The common voltage line, via the second transistor of the unit pixel, charges the first electrode of the second storage capacitance of the lower row unit pixel to the common voltage. And when lower scan line turns on the first transistor of the lower row unit pixel, the data line, via the first transistor of the lower row unit pixel, charges the first electrode of the second storage capacitance of the lower row unit pixel to a gray scale voltage.

### BRIEF DESCRIPTION OF THE DRAWINGS

The above objects, and other features and advantages of the present invention will become more apparent after reading the following detailed description when taken in conjunction with the drawings, in which:

FIG. 1 illustrates the prior art of driving circuit of a TFT-LCD.

FIG. 2 illustrates the prior art of data line reducing technique.

FIG. 3 illustrates the pixel array with pre-charge function of present invention.

FIG. 4 illustrates the voltage levels of Dot Inversion operation.

FIG. 5a illustrates the charged voltage of the pixel without pre-charge function.

FIG. 5b illustrates the charged voltage and the pre-charging process of the pixel with pre-charge function.

FIG. 6 illustrates to build the pixel with pre-charged function in the technique of dual gate data line reducing by adding a pre-charging transistor.

FIG. 7 illustrates to build the pixel with pre-charged function in the technique of triple gate data line reducing by adding a pre-charging transistor.

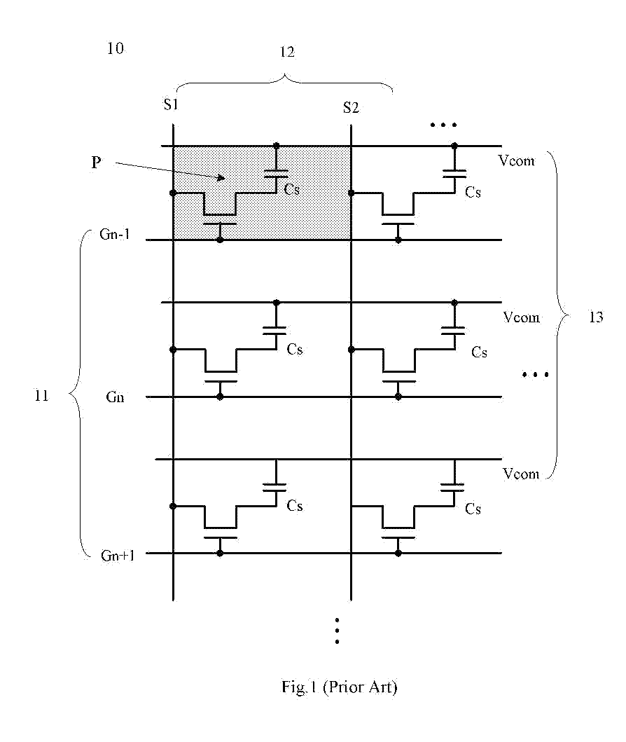

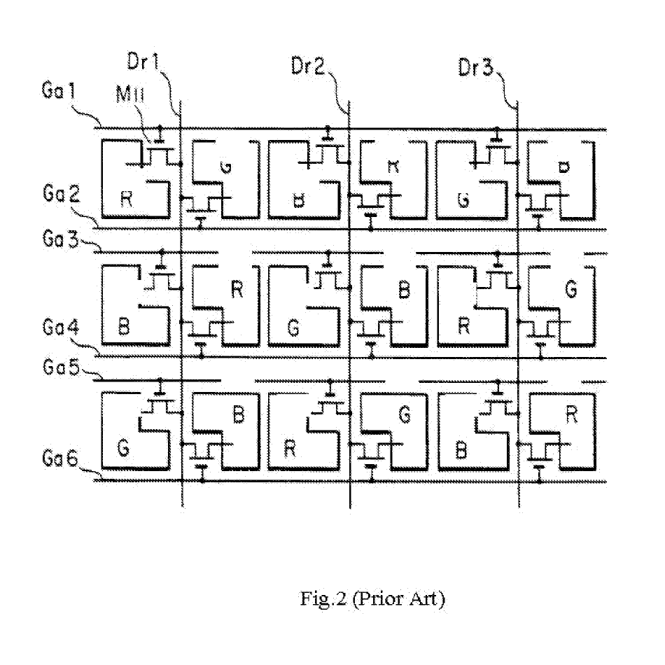

### DETAILED DESCRIPTION

The present invention will be described in detail by using the following embodiments and it will be recognized that those descriptions and examples of embodiments are used to illustrate but not to limit the claims of the present invention. Hence, other than the embodiments described in the following, the present invention may be applied to the other substantially equivalent embodiments.

The present invention discloses a pixel structure with pre-charge function. Normally, there is one transistor (hereinafter called pixel transistor) for every pixel to act as a switch to control the pixel. The pixel structure of present invention adds an additional transistor (hereinafter called pre-charge transistor) to act as pre-charge switch which can pre-charge a pixel to a common voltage before the pixel is turned on so as to reduce the charging or discharging time while the pixel updates its new gray scale voltage.

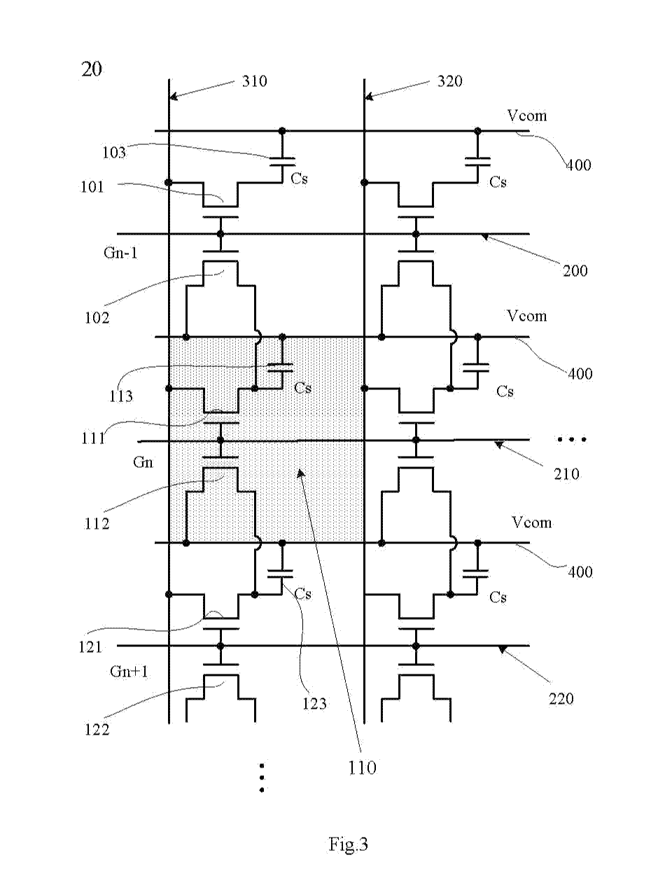

In one embodiment, as shown in FIG. 3, the driving circuit 20 of a TFT-LCD contains a plurality of scan lines, a plurality of data lines, and a plurality of unit pixels. A unit pixel 110 includes a pixel transistor 111, a pre-charge transistor 112, and a storage capacitance 113. The pixel transistor 111 and the pre-charge transistor 112 have three nodes: a gate, a source, and a drain, wherein the gate is the controlling node to control ON/OFF of the transistor. The gate of the pixel transistor 111 is controlled by the scan line 210, the source of the pixel transistor 111 is electrically connected with the data line 310, and the drain of the pixel transistor 111 is electrically connected to the first electrode (or upper electrode) of the storage capacitance 113. The second electrode (or lower electrode) of the storage capacitance 113 is electrically coupled to the common voltage line 400 and the second electrode of the other storage capacitances. Similarly, the gate of the pre-charge transistor 112 is controlled by the scan line 210, the source of the pre-charge transistor 112 is electrically coupled to the common voltage line 400, and the drain of the pre-charge transistor 112 is electrically connected to the first electrode of the storage capacitance 123 which is located in the next row and the same column.

In one embodiment, the above-mentioned pixel transistor 111 and pre-charge transistor 112 include Thin Film Transistor (TFT), or the other transistors, such as Bipolar Junction Transistor (BJI), which have three nodes. The connection or disconnection of the channel between two nodes of the transistors is controlled by a control node.

Referring to FIG. 3, TFT-LCD will sequentially activates the scan lines of the driving circuit 20. When the scan line 210 is activated, both the pixel transistor 111 and the pre-charge transistor 112 are turned on, and the data line 310 will, via the pixel transistor 111, charge the storage capacitance 113 to a gray scale voltage. Owing to the pre-charge transistor 112 is turned on simultaneously, the storage capacitance 123 of the pixel in next row is charged to a common voltage in advance. Therefore, when the lower scan line 220 is activated, the storage capacitance 123 of the pixel in next row will be charged from the common voltage Vcom. In general, a pixel of a TFT-LCD is driven alternatively by a positive voltage and a negative. The two voltages are symmetric and with reference to a common voltage Vcom. Provided that the storage capacitance 113 of the pixel 110 is pre-charged to a common voltage Vcom, the charging time for the pixel 110 being charged to a gray scale voltage can be reduced when the pixel transistor 111 is driven by the scan line 210. Therefore, it overcomes the issue of insufficient charging or discharging time generally happened in high resolution panel and low temperature environment.

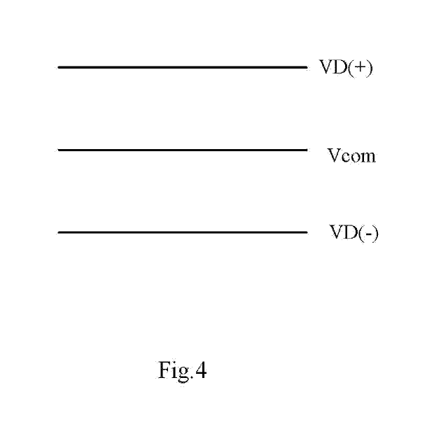

Hereinafter, Dot Inversion driving method is utilized to describe the theory of the present invention. Provided that there are three voltage levels in the display driving circuit, as shown in FIG. 4, VD(+) and VD(−) are positive and negative voltages and the two voltage levels are symmetrical with reference to Vcom. The voltage level of the storage capacitance of a pixel switches among the three voltage levels: VD(+), VD(−) and Vcom. Referring to FIG. 3, given that the initial states of the storage capacitances 103, 113, and 123 are Vcom, VD(+), and VD(−) respectively, in the condition that the upper scan line 200 is activated and the voltage level of data line 310 is VD(+), the storage capacitance 103 and 113 will be charged to VD(+) and Vcom, respectively whereas the storage capacitance 123 still holds VD(−). When the scan line 210 is activated and the voltage level of data line 310 is switched to VD(−), the storage capacitance 113 is charged from Vcom to VD(−) whereas the storage capacitance 123 will be charged to Vcom by the pre-charge transistor 112.

The Dot Inversion driving method is that every pixel in the display will be alternatively driven a pair of opposite voltages, such as VD(+) and VD(−). Provided that the storage capacitance 113 of the unit pixel 110 is initially charged by VD(+), the capacitance 113 should be charged by VD(−) next time. As far as the unit pixel 110 is concerned, when the upper scan line 200 is activated, the pre-charge transistor 102 will charge the storage capacitance 113 of the unit pixel 110 to Vcom in advance. Hence, once the unit pixel 110 is driven, the storage capacitance 113 only needs to charge from Vcom to VD(−). Without the pre-charge transistor 102 of the present invention, the storage capacitance 113 of the unit pixel 110 should be charged from the initial state, VD(+), to VD(−) under the Dot Inversion operation mode. It is obvious that it will need longer charge time without the pre-charge transistor of the present invention.

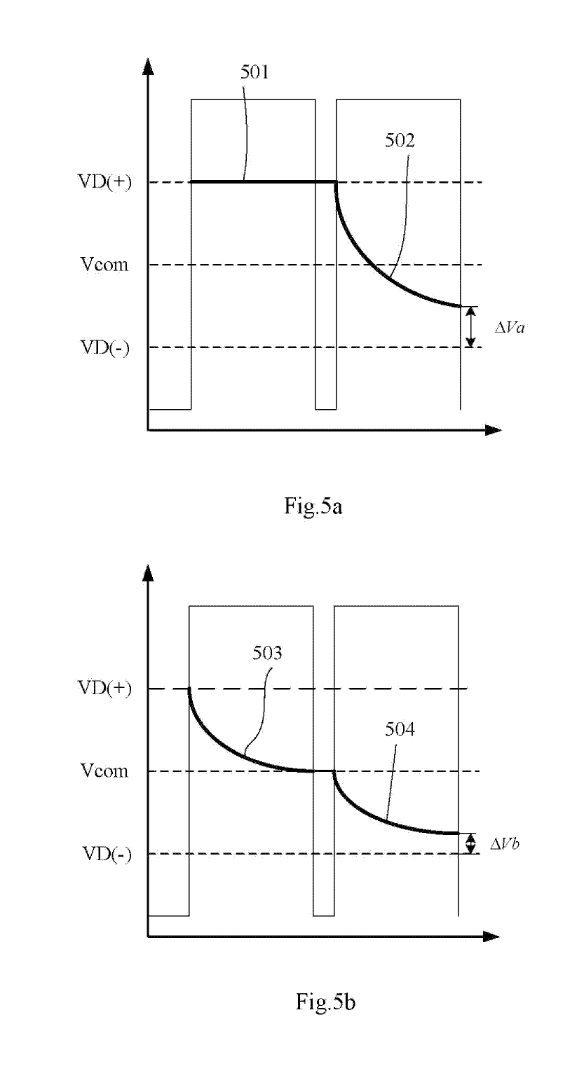

FIG. 5a shows the charging process of the traditional pixel. Referring to FIG. 3 also, in the duration 501 when the upper scan line 200 is driven, the storage capacitance 113 of the unit pixel 110 still retains VD(+) and then in the duration 502 when the scan line 210 is driven, the storage capacitance 113 is charged to the voltage with ΔVa above VD(−). However, the pixel of the present invention can reduce the charging time effectively. As shown in FIG. 5b, in the duration 503 when the scan line 200 is driven, the storage capacitance 113 of the unit pixel 110 still will be pre-charged to Vcom, and then in the duration 504 when the scan line 210 is driven, the storage capacitance 113 is charged to the voltage with ΔVb above VD(−), wherein ΔVb is smaller than ΔVa or even ½ ΔVa. Obviously, the pixel structure with pre-charge function of present invention can improve the issue of insufficient charging.

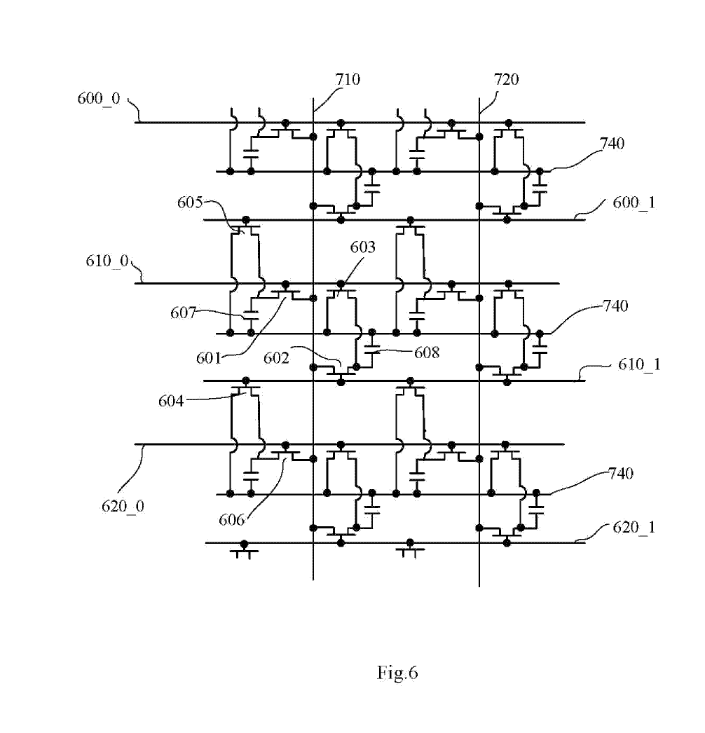

In one embodiment, the pixel with pre-charge function of the present invention is applied on the display with dual gate data line reducing technique. As shown in FIG. 6, in dual gate data reducing display, the adjacent left and right pixels share one data line and there are two scan lines, the upper and the lower, for the pixels on one row. The upper scan line 610_0 connects with the control nodes (or gates) of two transistors (or TFTs) 601, 603, and the lower scan line 610_1 connects with the control nodes (or gates) of two transistors (or TFTs) 602, 604. Regarding the transistors 601, 603 controlled by the upper scan line 610_0, the two nodes of transistor 601 are electrically connected to the shared data line 710 and the upper electrode of the storage capacitance 607, respectively; whereas the two nodes of the transistor 603 are connected to the common voltage line 740 and one node of transistor 602, respectively. Regarding the transistors 602, 604 controlled by the lower scan line 610_1, the two nodes of transistor 602 are electrically connected to the shared data line 710 and the upper electrode of the storage capacitance 608, respectively; whereas the two nodes of the transistor 604 are connected to the common voltage line 740 and one node of transistor 606 located in the lower row, respectively.

When the upper scan line 610_0 is activated, both the transistor 601 603 are turned on so the data line 710, via transistor 601, charges the storage capacitance 607 to a gray scale voltage and the common voltage line 740, via transistor 603, charges the storage capacitance 608 to the common voltage, Vcom. The capacitance 608 is the storage capacitance of the pixel controlled by the lower scan line 610_1 in next row. Before the upper scan line 610_0 is activated, the scan line 600_1 will turn on the transistor 605 first and thereupon the storage capacitance 607 is charged to the common voltage Vcom in advance.

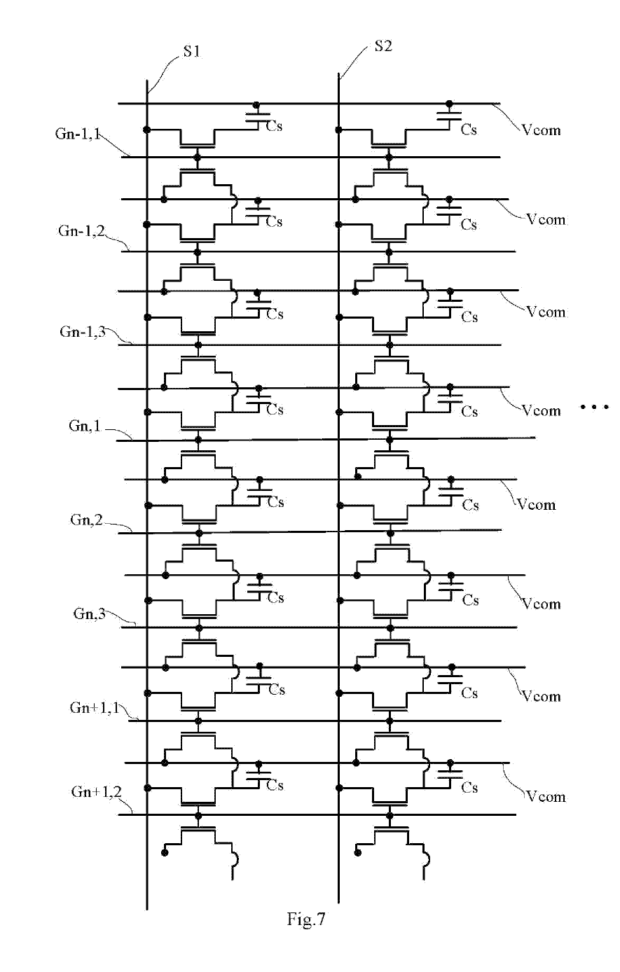

In one embodiment, the pixel with pre-charge function of the present invention is applied on the display with triple gate data line reducing technique. As shown in FIG. 7, in the triple gate data reducing display, one pixel contains three sub-pixels, a scan line and three data lines. The three sub-pixels are controlled by three scan lines, respectively, and share one data line. It can be understood that the pixel structure of the triple gate data reducing and the operation theory is same as the embodiment shown in FIG. 3.

Although preferred embodiments of the present invention have been described, it will be understood by those skilled in the art that the present invention should not be limited to the described preferred embodiments. Rather, various changes and modifications can be made within the spirit and scope of the present invention, as defined by the following Claims.

What is claimed is:

1. A pixel structure with pre-charge function, the structure exhibits a pixel array which comprises a plurality of scan lines and a plurality of data lines, wherein a unit pixel formed between two adjacent scan lines and two adjacent data lines; said unit pixel comprises:
a first storage capacitance comprising a first electrode and a second electrode;
a first transistor comprising a gate, a source and a drain, wherein said drain of said first transistor is electrically connected to said first electrode of said first storage capacitance;
a second transistor comprising a gate, a source and a drain, wherein said drain of said second transistor is electrically connected to a first electrode of a second storage capacitance of a lower row unit pixel;
a scan line electrically connected to said gate of said first transistor and said gate of second transistor;
a data line electrically connected to said source of said first transistor;
a common voltage line electrically connected to said source of said second transistor and said second electrode of said first storage capacitance; and
when said scan line activates said gate of said first transistor and said gate of said second transistor, said data line, via said first transistor, charges said first electrode of said first storage capacitance to a gray scale voltage, and said common voltage line, via said second transistor, charges said first electrode of said second storage capacitance of said lower row unit pixel to a common voltage.

2. A pixel structure with pre-charge function according to claim 1, wherein said second electrode of said first storage capacitance is electrically coupled to said common voltage line and a second electrode of a storage capacitance of the other unit pixels.

3. A pixel structure with pre-charge function according to claim 1, wherein said drain of said first transistor is electrically connected to a drain of a second transistor of an upper row unit pixel.

4. A pixel structure with pre-charge function according to claim 3, wherein a gate of said second transistor of said upper row unit pixel is controlled by an upper scan line, and a source of said second transistor of said upper row unit pixel is electrically connected to said common voltage line;
when said upper scan line turns on said second transistor of said upper row unit pixel, said scan line is off and said first electrode of said first storage capacitance is charged to said common voltage by said second transistor of said upper row unit pixel.

5. A pixel structure with pre-charge function according to claim 1, wherein said drain of said second transistor of said unit pixel is electrically connected to a drain of a first transistor of said lower row unit pixel.

6. A pixel structure with pre-charge function according to claim 5, wherein a gate of said first transistor of said lower row unit pixel is controlled by a lower scan line, and a source of said first transistor of said lower row unit pixel is electrically connected to said data line.

7. A pixel structure with pre-charge function according to claim 6, when said lower scan line turns on said first transistor of said lower row unit pixel, said data line, via said first transistor of said lower row unit pixel, charges said first electrode of said second storage capacitance of said lower row unit pixel to a gray scale voltage.

8. A pixel structure with pre-charge function according to claim 7, when said scan line turns on said first transistor and said second transistor of said unit pixel, said lower scan line is off and said common voltage line, via said second transistor of said unit pixel, charges said first electrode of said second storage capacitance of said lower row unit pixel to said common voltage.
